(19) United States
(12) Patent Application Publication
(10) Pub. No.: US 2025/0204594 A1
(43) Pub. Date: Jun. 26, 2025

(54) Heating Assembly for an Aerosol Generating Device

(71) Applicant: JT International S.A., Geneva (CH)

(72) Inventors: Alec Wright, Guildford (GB); Eduardo Jose Garcia Garcia, Grand-Saconnex (CH)

(73) Assignee: JT International S.A., Geneva (CH)

(21) Appl. No.: 18/851,220

(22) PCT Filed: Apr. 3, 2023
(86) PCT No.: PCT/EP2023/058684

§ 371 Date: Sep. 26, 2024

(30) Foreign Application Priority Data
Apr. 5, 2022 (EP) 22166786.8

(51) Int. Cl. A24F 40/46; A24F 40/20; A24F 40/70

(52) U.S. Cl. CPC A24F 40/46; A24F 40/70; A24F 40/20

(57) ABSTRACT

A heating assembly for an aerosol generating device includes a heating chamber having an opening for receiving an aerosol substrate. The heating chamber includes a first tubular portion made from ceramic material and, at least one second tubular portion made from metallic material or thermal-resistant plastic. The heating element is configured to heat the first tubular portion. The at least one second tubular portion is connected to an end of the first tubular portion.

### FIELD OF THE INVENTION

The present invention relates to a heating assembly for an aerosol generating device and an aerosol generating device comprising such a heating assembly. The disclosure is particularly applicable to a portable aerosol generating device, which may be self-contained and low temperature.

### BACKGROUND OF THE INVENTION

For heating an aerosol substrate, there are known heating assemblies comprising a heating chamber for receiving the aerosol substrate and heating elements for heating the heating chamber. The heating chamber is generally wrapped in a thin-film metal heater. However, this heating chamber is not completely satisfying.

Other heating chambers are made from materials with properties that enhance the heating of the aerosol substrate and thus enhance the user experience. For example, there are known heating chambers made from a ceramic material.

However, these heating chambers require significant energy to reach an aerosolization temperature and the heat is distributed homogeneously, which does not allow targeting of a specific region of the heating chamber.

### SUMMARY OF THE INVENTION

The invention aims first of all at solving, at least in part, the drawbacks of the prior art. The invention also aims to provide a heating assembly that provides satisfactory heat penetration, while targeting the concentration of heat to a specific area of the heating assembly.

The present invention thus relates to a heating assembly for an aerosol generating device, comprising a heating chamber having an opening for receiving an aerosol substrate, said heating chamber comprising a first tubular portion made from ceramic material and at least one second tubular portion made from metallic material or thermal-resistant plastic, a heating element configured to heat said first tubular portion. The at least one second tubular portion is connected to an end of the first tubular portion.

By thermal-resistant plastic, also known as heat-resistant plastic, the present invention refers to polymeric materials with a relatively high heat resistance, for example above 100° C., or 150° C.

In the heating assembly according to the invention, the first tubular portion is connected at one of its longitudinal ends to a second tubular portion to form a tubular assembly comprising a ceramic portion joined to a metallic material portion or a thermal-resistant plastic portion.

In other words, the heating chamber comprises a junction or an interface between the first tubular portion made of ceramic and the at least one second tubular portion made of metallic material or thermal-resistant plastic.

The connection between the first tubular portion made of ceramic material and the second tubular portion made of metallic material or thermal-resistant plastic creates an area of thermal resistance variation and leads to the formation of a thermal break. The thermal break reduces or even prevents the diffusion of heat towards a longitudinal end of the first tubular portion.

When heating element heats the first tubular portion, the heat diffuses except towards the interface or junction with the second tubular portion. The heat is thus concentrated on a part of the first tubular portion located remotely from the second tubular portion, and more particularly from the junction or interface between the first portion and the second portion. In other words, it is the junction or interface between the ceramic and the metallic material or thermal-resistant plastic at a longitudinal end of the first tubular portion that allows to concentrate the heat in a specific region of the first tubular portion.

As it is known that ceramic has a high thermal mass, ceramic material requires more energy than a metal tubular portion to reach a specific temperature. The addition of at least one second tubular portion of metallic material or thermal-resistant plastic at a longitudinal end of the first tubular portion enables to reduce the total thermal mass of the first tubular portion and thus reduces the energy consumption to reach the specific temperature.

Moreover, the use of ceramic material for the heating chamber allows a better heat penetration in the tobacco. This leads to improved sensory performance with fuller vapour and higher nicotine levels depending on the aerosol substrate.

Particularly simple, convenient and economical preferred features of the heating assembly according to the invention are presented below.

The second tubular portion may be made from stainless steel or polyether ether ketone (PEEK). In other words, the metal material may be stainless steel while the thermal-resistant plastic may be PEEK.

The metallic material may also be copper or aluminum. The thermal-resistance plastic may also be others engineering plastics such as Polyetherimide (PEI) or Polyphenylenesulfide (PPS). The second tubular portion may be abutted to said end of the first tubular portion.

The first tubular portion may have a thinned end portion forming a shoulder, the at least one second tubular portion having an end bearing against said shoulder.

The at least one second tubular portion may cover a circumferential surface of the first tubular portion located on the side of the end of said first tubular portion.

In other words, at least a portion of the second tubular portion entirely surrounds a surface of the first tubular portion.

The circumferential surface of said first tubular portion which is covered by the second tubular portion may be an inner surface of said first tubular portion.

The first tubular potion and the at least one second tubular portion may be connected by a tight fit.

The first tubular portion and the at least one second tubular portion may be sealed. By sealing is meant any means by which the first tubular portion is joined in fluid-tight manner to the at least one second tubular portion. Thus, the first and second tubular portions may be sealed by brazing, welding, gluing, screwing, riveting, shrinking or sealant application for example a high temperature silicon based sealant.

The first tubular portion may represent between 10% and 90% of a length of said heating chamber. Preferably, the first tubular portion may represent about 50% of the length of the heating chamber.

The ceramic material of said first tubular portion may be aluminum nitride (AlN), silicon carbide (SiC), silcion nitride (Si₂N₄) or beryllium oxide (BeO). Aluminum nitride is preferred in this application.

The heating element may be formed as a meandrous pattern on the first tubular portion.

The first tubular portion comprises one or more flattened regions that extend in an axial direction of the heating chamber.

The heating assembly may comprise two second tubular portions. The two second tubular portions may be connected to the first tubular portion respectively at a first end of the first tubular portion and a second end of the first tubular portion which is axially opposite the first end, and said two second tubular portions being spaced in an axial direction of the heating chamber.

The second tubular portions may be made from stainless steel or PEEK (polyether ether ketone).

With two second tubular portions located axially on either end of the first tubular portion, the heat is more concentrated on the first tubular portion.

The second tubular portions may be abutted to said first end and said second end of the first tubular portion.

The first tubular portion may be centered between a first end of said heating chamber and a second end of the heating chamber which is axially opposite the first end.

The heating element may extend axially on the first tubular portion between second tubular portions.

According to another aspect, the present invention relates to an aerosol generating device comprising a battery and a heating assembly as recited above, wherein said heating element is electrically supplied by the battery.

The aerosol generating device presents the same advantages as the ones described in relation with the heating assembly.

### BRIEF DESCRIPTION OF THE DRAWINGS

Other particularities and advantages of the invention will also emerge from the following description.

In the accompanying drawings, given by way of non-limiting examples:

FIG. 1 shows an aerosol generating device represented schematically in semi-transparency and comprising a battery and a heating assembly according to the invention;

FIG. 2 is a perspective view of a heating assembly according to a particular embodiment of the invention; and

FIG. 3 is a sectional view of the heating assembly through the axis A shown in FIG. 2.

### DETAILED DESCRIPTION

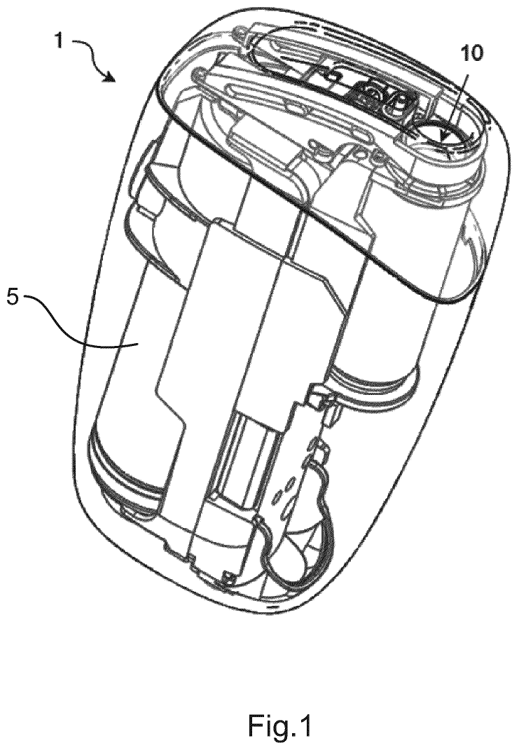

FIG. 1 represents an aerosol generating device 1 according to an embodiment. The aerosol generating device 1 is illustrated in an assembled configuration with the internal components visible. The aerosol generating device 1 is a heat-not-burn device, which may also be referred to as a tobacco-vapour device, and comprises a heating assembly 10 and a battery electrically connected to the heating assembly 10.

The heating assembly 10 is configured to receive an aerosol substrate such as a rod of aerosol generating material, e.g. tobacco. The heating assembly is also configured to convert electrical energy supplied by the battery 5 into thermal energy. To this end, the heating assembly 10 is operable to heat, but not burn, the rod of aerosol generating material to produce a vapour or aerosol for inhalation by a user. Of course, the skilled person will appreciate that the aerosol generating device 1 depicted in FIG. 1 is simply an exemplary aerosol generating device according to the invention. Other types and configurations of tobacco-vapour products, vaporisers, or electronic cigarettes may also be used as the aerosol generating device according to the invention.

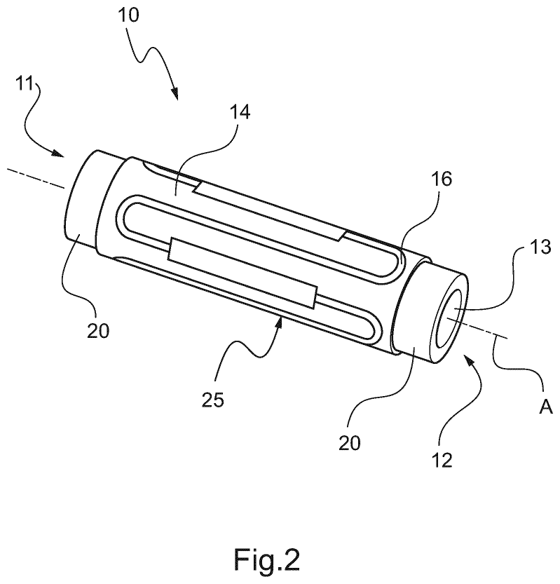

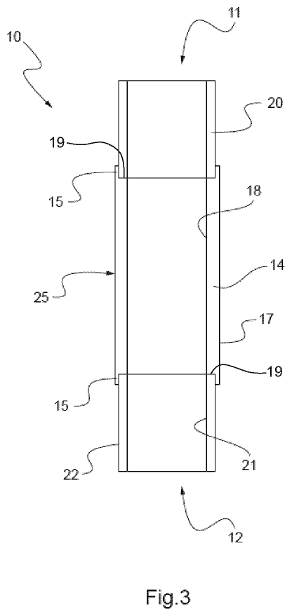

The heating assembly 10, according to an embodiment, is best seen in FIGS. 2 and 3.

The heating assembly 10 comprises a heating chamber 25, also referred to as a thermally conductive shell, configured to hold an aerosol substrate, also referred to as a consumable. In particular, the heating chamber 25 defines here a substantially cylindrical cavity in which a rod of aerosol substrate may be positioned. The heating chamber 25 is tubular, e.g. substantially cylindrical, and defines a central passage 13 open to a first end 11 of the heating chamber 25 and a second end 12 of the heating chamber 25, axially opposite the first end 11. In other words, the central passage 13 is accessible from each of the first end 11 and the second end 12 via openings.

Alternatively, the central passageway may have only one opening located at either of the first end and the second end of the heating chamber.

In use, the user may insert the aerosol substrate through an opening in the heating chamber 25 such that the aerosol substrate is positioned within the heating chamber 25 and interfaces with an inner surface of the heating chamber 25. The length of the heating chamber 25 may be configured such that a portion of the aerosol substrate protrudes through an opening from the heating chamber 25, i.e. out of the heating assembly 10, and can be received in the mouth of the user.

According to a particular embodiment of the invention, the heating chamber 25 includes a first tubular portion 14 and two second tubular portions 20 connected to the first tubular portion 14.

Alternatively, the heating chamber 25 may include a first tubular portion and only one second tubular portion connected to one end of the first tubular portion.

The first tubular portion 14 has here a circular cross-section and also has a first end and a second end axially opposite the first end. In other words, the first tubular portion 14 is tubular, e.g. substantially cylindrical.

Alternatively, the first tubular portion may be substantially cylindrical but comprises one or more flattened regions that extend in an axial direction of the heating chamber.

The first tubular portion 14 is made from a ceramic material, and more particularly aluminum nitride (abbreviated as AlN) in the illustrated example.

Due to its construction of a ceramic material, the first tubular portion 14 has high thermal mass and provides good heat penetration into the aerosol substrate, especially when said aerosol substrate includes tobacco. This allows for improved sensory performance with a fuller vapor and a higher nicotine level when the aerosol substrate contains tobacco.

The first tubular portion 14 comprises a thinned end portion 15 at its first end and at its second end. The thinned end portion 15 has a thickness that is less than the thickness of the rest of the first tubular portion 14. In particular, the inner diameter of the first tubular portion 14 at the thinned end portions 15 is greater than the inside diameter of the rest of the first tubular portion 14. In other words, the first tubular portion 14 is provided with a counterbore at its first end and at its second end.

Alternatively, the inner diameter of the first tubular portion may be constant along the entire length of the first tubular portion while its outer diameter at the thinned end portions may be smaller than the outer diameter of the rest of the first tubular portion.

The change in diameter at the thinned end portions 15 of the first tubular portion 14 forms a shoulder 19. In the illustrated example, the shoulder 19 is formed on an inner surface 18 of the first tubular portion 14.

Alternatively, the shoulder may be formed on the outer surface of the first tubular portion.

The thinned end portions 15 extend to a length of between 15% and 25% of the length of the first tubular portion 14. In particular, each thinned portion 15 has a length, in the longitudinal direction of the first tubular portion 14, between 0.25 mm and 2 mm, preferably between 0.75 mm and 1.5 mm and more preferably equal to 1 mm.

The thinned end portions 15 have a thickness between 0.10 mm and 0.5 mm. The first tubular portion 14 has, on the rest of his length, i.e. with the exception of the thinned end portions, has a thickness between 0.15 mm and 0.75 mm.

The heating assembly 10 comprises heating element 16 configured to act as a Joule heater when supplied with electrical current. In other words, the heating element 16 is configured to release heat in response the flow of electrical current. This physical effect may be referred to as Joule heating, resistive heating or ohmic heating. In use, power may be supplied to the heating element 16 from the battery 5 for example, such that the temperature of the heating element 16 increases and heat energy is transferred across the heating chamber 25 and more particularly to the first tubular portion 14. The aerosol substrate received within the heating assembly 1 is conductively heated by the heating chamber 25 to produce an aerosol for inhalation by the user.

The heating element 16 is here located on an outer surface 17 of the first tubular portion 14. Alternatively, the heating element may be integrated into the first tubular portion, that is, located between an inner surface and an outer surface of the first tubular portion. According to another alternative, the heating element may be located at a distance, i.e. not in direct contact, from the first tubular portion and transmit heat by convection for example.

The heating element 16 is here formed as a meandrous or serpentine pattern coating on the outer surface 17 of the first tubular portion 14. For example, the heating element 16 may be shaped by etching, masking, or laser cutting to form the illustrated pattern. Of course, the skilled person will appreciate that the specific pattern formed by the heating element 16 may vary, depending on the functional requirements of the heating assembly 1. The pattern forms an electrical path such that, in use, electrical current supplied from the battery 5 to the heating element 16 travels along the electrical path and generates heat energy. The heating element 16 is made from any material that acts as a Joule heater when supplied with an electric current, such as tungsten for example. Other materials having a coefficient of thermal expansion substantially matching that of the ceramic material may be considered.

The second tubular portions 20 have here a circular cross-section and each have a first end and a second end axially opposite the first end. In other words, the second tubular portions 20 are tubular, e.g. substantially cylindrical.

Alternatively, the second tubular portions may be substantially cylindrical but comprise one or more flattened regions that extend in an axial direction of the heating chamber.

Each second tubular portion 20 has a constant cross-section, i.e., the outer diameter and inner diameter of the second tubular portion are constant along its length.

Alternatively, the second tubular portions have a thinned end portion, similar to the thinned end portion described for the first tubular portion, located at one end of the second tubular portions. When the second tubular portions have a thinned portion, the first tubular portion may not have a thinned end portion. The second tubular portions 20 have a thickness between 0.05 mm and 0.15 mm.

The second tubular portions 20 are made from metallic material or thermal-resistant plastic. For example, the metallic material is stainless steel, copper, aluminum or any other suitable material. The thermal-resistance plastic is for example an engineering plastic such as Polyetherimide (PEI), Polyphenylenesulfide (PPS) or Polyether ether ketone (PEEK).

In some examples, PEEK may be preferred over stainless steel due to the fact that it has thermal expansion properties more similar to the ceramic material of the first tubular portion 14.

As shown in FIGS. 2 and 3, the second tubular portions 20 are each connected to one end of the first tubular portion 14.

In the illustrated embodiment, each second tubular portion 20 is plugged, at least partially, into the first tubular portion 14 at the location of the thinned portions 15. The second tubular portions 14 are inserted in translation along the longitudinal direction of the first tubular portion 14 until they come into contact with the shoulder 19. The second tubular portions 20 are thus axially spaced apart from each other by the first tubular portion 14. Thus, the second tubular portions 20 abut the first end and the second end of the first tubular portion 14.

The thinned end portions 15 of the first tubular portion 14 circumferentially surround at least part of the second tubular portions 20. In other words, the thinned end portions 15 at least partially overlap part of the second tubular portions 20. Correspondingly, at least part of the second tubular portions 20 overlaps the inner surface 18 of the first tubular portion 14 at the location of the thinned end portions 15.

Alternatively, at least part of the second portions covers the outer surface of the first tubular portion at the location of the thinned portions or at the location of its ends in the case where the first tubular portion has no thinned portions.

Each second tubular portion 20 is inserted into the first tubular portion 14 with a tight fit. The tight fit reduces vapor leakage and thus helps to deliver a greater amount of aerosol to the user. The tight fit also improves contact and heat exchange between the first tubular portion 14 and the second tubular portions 20. Thus, there is at least one contact area between the first tubular portion 14 and the second tubular portions 20. In particular, a first contact area is located between the shoulders 19 and the surface of each second tubular portion 20 bearing against these shoulders 19. A second contact area is formed between the inner surface 18 of the first tubular portion 14 at the location of the tapered portions 15 and part of the outer surface 22 of the second tubular portions 20. The second contact zone is preferably circumferential.

In order to provide the tight fit, the outer diameter of the second tubular portions 20 is slightly smaller than, or equal, to the inner diameter of the first tubular portion 14 at the tapered portions 15.

Alternatively, the external diameter of the first tubular portion is less than the inner diameter of the second tubular portions at the thinned end portion. This is applicable when the second tubular portions comprise a thinned end portion or when the first tubular portion comprises thinned end portions and the shoulder is located on the outer surface.

Alternatively, the first tubular portion and the second tubular portion may be joined by threading, in which case an inner or outer circumferential surface at the location of the thinned end portion is threaded. When the first tubular portion comprise tapered end portions, an inner or outer surface of the second tubular portions is threaded so as to cooperate with the thread of the circumferential surface of the thinned end portion. When the second tubular portions each comprise a thinned end portion, an inner or outer surface of the first tubular portion is threaded so as to cooperate with the thread of the circumferential surface of the thinned end portion.

Alternatively, neither the first tubular portion nor the second tubular portions have a thinned end portion. In this case, the portions are fixed end to end, i.e. by their end face, without overlapping the circumferential surface of the first tubular portion. The portions can be maintained between them for example by gluing, welding, locating pin. Of course, the skilled person will appreciate that the specific means for assembling the first tubular portion 14 and the second tubular portions 20 may vary, depending on the functional requirements of the heating chamber 25.

After being assembled, the first tubular portion 14 and the second tubular portions 20 are sealed. In the illustrated example, the first tubular portion 14 are sealed to the second tubular portions 20 by brazing.

The sealing further reduces the risk of aerosol leakage between the first tubular portion 14 and the second tubular portions 20.

The first tubular portion 14 and the second tubular portions 20 have a substantially equal inner diameter, except for the thinned portions, so that when assembled, the passage 13 of the heating assembly 10 has a substantially constant cross-section. In particular, this allows for improved aerosol flow within the heating assembly 10.

The second tubular portions 20 have a length along the longitudinal axis A of the heating chamber 25 that is less than the length of the first tubular portion 14. In particular, the cumulative length of the second tubular portions 20 is between 10% and 90%, preferably about 50%, of the total length of the heating assembly 10.

In the example shown, the second tubular portions 20 are identical and therefore have the same length. Thus, the first tubular portion 14 is at the center of the heating assembly 10. In other words, the first tubular portion 14 is centered with respect to the first end 11 and the second end 12 of the heating assembly 10.

When the heating element 16 is powered by an electric current supplied by the battery 5 of the aerosol generating device 1, this heating element 16 converts the electric energy into heat, which is transmitted by conduction to the first tubular portion 14. Due to the assembly of the first tubular portion 14 and the second tubular portions 20 described above, the heat is concentrated in the center, i.e. between the ends, of the first tubular portion 14.

Thanks to the invention, the heating assembly 10, and more particularly the first tubular portion 14 made of ceramic material, requires less electrical energy to reach a given temperature than a heating assembly formed by a single ceramic tube, for example. In addition, the invention provides a heating assembly with a ceramic material portion, and thus with improved heat penetration compared to a thin metal film, which delivers heat in a concentrated manner.

1. A heating assembly for an aerosol generating device, comprising:
a heating chamber having an opening for receiving an aerosol substrate, said heating chamber comprising:
a first tubular portion made from a ceramic material and,
at least one second tubular portion made from a metallic material or a thermal-resistant plastic,
a heating element configured to heat said first tubular portion,
wherein said at least one second tubular portion is connected to an end of the first tubular portion.

2. The heating assembly according to claim 1, wherein said second tubular portion is made from stainless steel or PEEK (polyether ether ketone).

3. The heating assembly according to claim 1, wherein said second tubular portion is abutted to said end of the first tubular portion.

4. The heating assembly according to claim 1, wherein the first tubular portion has a thinned end portion forming a shoulder, said at least one second tubular portion having an end bearing against said shoulder.

5. The heating assembly according to claim 1, wherein said at least one second tubular portion covers a circumferential surface of the first tubular portion located on the side of the end of said first tubular portion.

6. The heating assembly according to claim 5, wherein said circumferential surface of said first tubular portion is covered by said at least one second tubular portion is an inner surface of said first tubular portion.

7. The heating assembly according to claim 1, wherein said first tubular portion and said at least one second tubular portion are connected by a tight fit.

8. The heating assembly according to claim 1, wherein said first tubular portion and said at least one second tubular portion are sealed.

9. The heating assembly according to claim 1, wherein said first tubular portion represents between 10% and 90% of a length of said heating chamber.

10. The heating assembly according to claim 1, wherein the ceramic material of said first tubular portion is aluminum nitride.

11. The heating assembly according to claim 1, wherein said heating element is formed as a meandrous pattern on the first tubular portion.

12. The heating assembly according to claim 1, wherein said first tubular portion comprises one or more flattened regions extending in an axial direction of the heating chamber.

13. The heating assembly according to claim 1, wherein the at least one second tubular portion comprises two second tubular portions, and wherein said two second tubular portions are connected to the first tubular portion respectively at a first end of the first tubular portion and a second end of the first tubular portion axially opposite the first end, and said two second tubular portions are spaced in an axial direction of the heating chamber.

14. The heating assembly according to claim 13, wherein said first tubular portion is centered between a first end of said heating chamber and a second end of the heating chamber axially opposite the first end.

15. The heating assembly according to claim 13, wherein said heating element extends axially on the first tubular portion between second tubular portions.

16. The heating assembly according to claim 1, wherein the at least one second tubular portion comprises two second tubular portions, wherein said two second tubular portions are connected to the first tubular portion respectively at a first end of the first tubular portion and a second end of the first tubular portion axially opposite the first end, and said two second tubular portions are spaced in an axial direction of the heating chamber, and wherein said two second tubular portions are made from stainless steel or PEEK (polyether ether ketone).

17. An aerosol generating device comprising a battery and a heating assembly according to claim 1, wherein said heating element is electrically supplied by the battery.

18. The heating assembly according to claim 1, wherein said first tubular portion and said at least one second tubular portion are sealed by brazing.
